(19) United States
(12) Patent Application Publication
(10) Pub. No.: US 2023/0309474 A1
(43) Pub. Date: Oct. 5, 2023

(54) PLANT HOLDING DEVICE

(71) Applicant: PhytonIQ Technology GmbH, Oberwart (AT)

(72) Inventor: Martin PARAPATITS, Oberwart (AT)

(21) Appl. No.: 17/794,200

(22) PCT Filed: Feb. 18, 2020
(86) PCT No.: PCT/EP2020/054143

§ 371 Date: Jul. 20, 2022

(51) Int. Cl. A01G 31/02

(52) U.S. Cl. CPC A01G 31/02

(57) ABSTRACT

The invention relates to a holding device for plants, comprising a mounting means (1) and a holding means (2) arranged inside the mounting means (1), wherein the holding means (2) comprises at least two holding elements (5), wherein each holding element (5) is connected to the mounting means (1) via a resilient connecting means (3), and wherein the mounting means (1), the holding means (2) and the connecting means (3) are formed integrally with each other.

The invention relates to a holding device for plants with the features of the preamble of the independent patent claim.

According to the state of the art, aeroponics is a method in which plants are cultivated without substrate. In this, both the above-ground plant parts (such as leaves, stems, fruits etc.) and the underground plant parts (such as roots, tubers etc.) are in an exposed location in a gaseous atmosphere. The special feature compared to conventional cultivation of plants in a growth substrate such as soil is that the underground plant parts are also exposed.

In aeroponics, both irrigation and nutrient supply are provided by means of an aerosol, which may optionally contain fertilizers, growth promoters and other substances. The aerosol is usually atomized at regular intervals to ensure continuous moisture in the area of the underground plant parts.

Since the underground plant parts usually cannot keep the plants upright without a stabilizing substrate, the plants are preferably held respectively stabilized in the area of transition between the above-ground and underground plant parts.

Various holding devices used for this purpose are known in the prior art. Since this is a mass product and a large number of such holding devices can be used within an aeroponic system, the holding devices should on the one hand be easy and cost-efficient to manufacture. On the other hand, a safe and stable support for the plants should be made possible. Another important requirement for such plant supports is that a certain flexibility should be ensured to allow adaptation to the growth of the plant.

Existing plant supports often cannot be manufactured cost-effectively or have only limited flexibility with respect to the size of the plant to be held.

The disadvantages of the prior art are overcome with a holding device having the characterizing features of the independent patent claim.

The invention relates to a holding device for plants, comprising a mounting means and a holding means arranged within the mounting means. The holding means is in particular provided to hold a plant or a part of a plant. The mounting means is in particular provided to attach the holding device to a support or another element.

According to the invention, it is provided that the holding means comprises at least two holding elements, wherein each holding element is connected to the mounting means via a resilient connecting means.

The resilient connecting means enable a flexible connection between the holding elements and the mounting means. This makes it possible to adjust the holding device to plants with different diameters. The connecting means may generate a spring force that may act in the direction of the held plant part. Preferably, the connecting means are arranged such that the spring force of the connecting means acts on a common center.

For example, if two holding elements are provided, they may be arranged opposite each other. For example, if three or more, in particular four or five, holding means are provided, the spring force exerted by the connecting elements may act on a common center, which is substantially arranged in the center of the holding means. The spring force exerted by the holding elements on a plant part determines the holding force of the holding device according to the invention. Depending on the weight, size and sensitivity of the plant, the holding force may be adjusted.

Preferably, the connecting means do not exert any spring force in the completely relaxed state. The completely relaxed state is the state where no force is exerted on the connecting means from the outside. In particular, the completely relaxed state is the state where no plant is held by the holding means. If a plant is held by the holding means, the connecting means may exert a spring force on the plant to hold the plant.

Optionally, it may be provided that the mounting means is designed as a mounting ring. This enables the mounting means to be easily fixed to a further element, such as a support or a holding frame. For example, the mounting means can be inserted into a corresponding receiving area of the further element.

Optionally, it may be provided that the holding elements are of substantially circular arc-shaped design, the holding elements together forming a substantially circular holding means.

This allows the plants to be held as stably as possible. The holding elements may have the shape of an arc of a circle. If the holding elements are of circular arc-shaped design, they can together form a substantially circular or annular holding means. Alternatively, the holding elements together may not form a complete circle.

Optionally, the holding elements may also be of wedge-shaped design. This allows the tip of the wedge to be directed against the plant part to be held in each case.

Optionally, it may be provided that the holding means is substantially annular and has a holding opening.

Preferably, the holding opening serves to receive a part of a plant, in particular to hold the plant at the transition of the above-ground plant parts to the underground plant parts. If the holding means is of annular design, a particularly gentle support of the plant is possible, since the pressure applied to the plant is evenly distributed. The holding opening may have different sizes or diameters depending on the size of the plant to be received. For example, the holding opening may have a diameter between 1 mm and 5 cm. Preferably, the size of the holding opening is determined in the completely relaxed state of the connecting means.

Optionally, it may be provided that clearances are provided within the mounting means, which allow a free movability of the holding elements.

A free movability of the holding elements allows flexible adaptation of the holding means to the diameter of the plant at the held location. When the diameter increases, the holding elements can penetrate the clearances and thus escape. Optionally, the clearances may also allow a free movability of the connecting elements. In particular, the clearances may be interrupted by the connecting elements.

Optionally, it may be provided that at least one connecting means is designed as an angled connecting strut. This enables a simple construction of a resilient connecting means. In this case, an expansion of the diameter of the plant at the holding point leads to a compression of the connecting means or to a reduction of the angle between two partial struts of the connecting means, respectively.

Optionally, it may be provided that at least one connecting means is designed as an arcuate connecting strut.

This design provides an alternative simple construction of the connecting means.

Alternative designs are also possible for the connecting means, as long as the connecting means serve the purpose of applying a spring force to a holding element. For example, springs or the like may optionally also be used as connecting means.

Optionally, it may be provided that each holding element is connected to the mounting means via a plurality of connecting means.

This enables a stable construction. By selecting the number and shape of the connecting means, the spring force exerted by the holding elements can be varied.

Optionally, it may be provided that the mounting means, the holding means and/or the connecting means are made of or comprise a polymer material.

Optionally, it may be provided that the mounting means, the holding means and the connecting means are formed integrally with each other, For example, said elements may be produced as integral part in an injection molding process.

Optionally, it may be provided that the connecting means is made of or comprises an elastic material.

Preferably, at least the connecting means has an elastic material. This serves to provide a spring force by the inherent elasticity of the material.

In the context of the present invention, “elastic” preferably means that the elongation at rupture of a material is more than 150% preferably more than 200%. The holding force of the device can be changed due to the elasticity of the material. Alternatively, the holding force of the device can also be changed by the geometry of the connecting means or by the number of connecting means.

Optionally, it may be provided that the mounting means, the holding means and/or the connecting means has/have cavities. This serves to reduce the weight of the holding device. Optionally, also the flexibility or the resilience of the connecting means may be improved when they have cavities.

Optionally, it may be provided that a filler element promoting plant growth is arranged in the holding opening, wherein the filler element is preferably made of or comprises a water-soluble polymer material.

For example, the filler element may be used to hold a seed. This allows long-term cultivation of a plant without the need for transplanting. For example, a plant may remain in a single holding device from sowing to harvesting. Preferably, the filler element may be made of or comprise a water-soluble polymer material. For example, the filler element may be a gel-like polymer, such as agar or gelatin, which dissolves over an extended period of time due to the effects of water and humidity, or which may be penetrated by the roots of the germinating plant. Alternatively, the filler element may be a fibrous material, such as absorbent cotton. Optionally, the filler element may additionally contain growth-promoting substances, such as fertilizers, germination promoters or growth promoters.

Optionally, it may be provided that the holding device comprises a preferably cylindrical root cage which is connected or connectable to the mounting means.

In the intended use of the holding device, the root cage is preferably arranged in the area of the underground plant parts and serves to receive the roots of the plant. In this way, a limitation of the spread of the underground plant parts is achieved; which may be useful for limiting the volume occupied by the underground plant parts.

Optionally, it may be provided that the root cage has a preferably annular receiving area, which is configured to receive the mounting means.

Optionally, it may be provided that the root cage can be positively connected to the mounting means.

Further features of the invention become apparent from the patent claims, the figures and the exemplary embodiments.

In the following, the invention will be explained in detail with reference to exemplary embodiments. The exemplary embodiments merely serve to illustrate the invention and are not intended to limit the scope of protection.

In the figures:

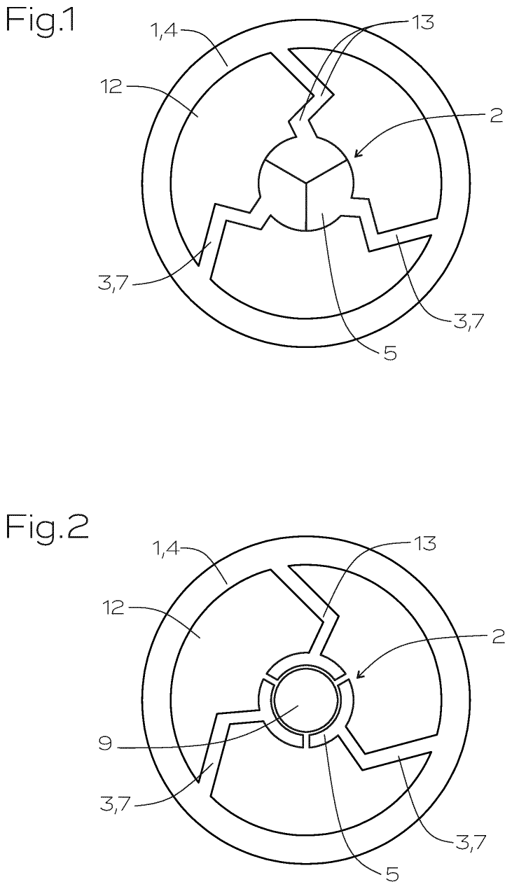

FIG. 1 shows a plan view of a first exemplary embodiment of a holding device according to the invention;

FIG. 2 shows a plan view of a second exemplary embodiment of a holding device according to the invention;

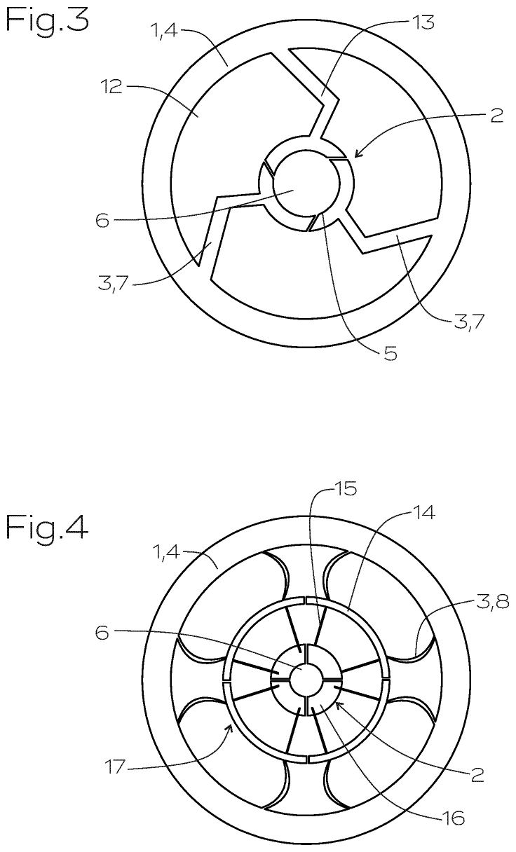

FIG. 3 shows a plan view of a third exemplary embodiment of a holding device according to the invention;

FIG. 4 shows a plan view of a fourth exemplary embodiment of a holding device according to the invention;

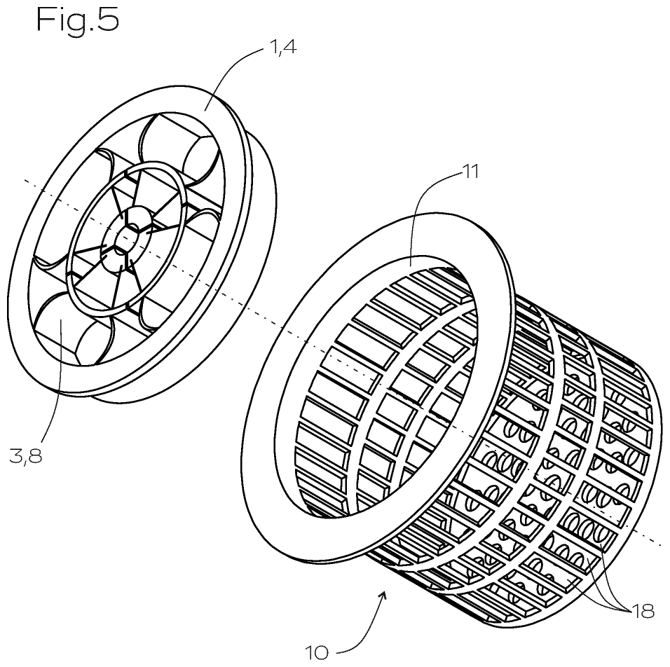

FIG. 5 shows a perspective view of a fifth exemplary embodiment of a holding device according to the invention with a root cage.

FIG. 1 shows a plan view of a first exemplary embodiment of a holding device according to the invention.

The holding device comprises an annular mounting means 1, which is designed as a mounting ring 4. On the inner surface of the mounting ring 4, three resilient connecting means 3 are arranged, On the opposite end of each connecting means, a holding element 5 is arranged. Together, the three holding elements 5 form a holding means 2.

In the view shown in FIG. 1, the holding device is shown in a completely relaxed position. Thus, the resilient connecting means 3 substantially do not exert any spring force respectively pressure on an element. In the completely relaxed position, the three holding elements 5 abut one another in the center of the holding device and form a substantially circular holding means 2. Since the holdings elements 5 are of wedge-shaped design, no opening is provided in the center of the holding means 2.

In this exemplary embodiment, the connecting means 3 are designed as angular connecting struts 7, wherein each connecting strut 7 has two bends 13. Clearances 12 are arranged between the connecting struts 7, enabling a free movability of the holding elements and the connecting struts 7.

For example, when a plant is introduced into the holding device at the transition between the above-ground and underground plant parts, it is secured by the interaction of the holding elements 5. The holding elements 5 are pushed towards the mounting ring 4, thereby applying a spring force to the holding elements 5 starting from the connecting means 3. The spring force acts substantially in the direction of the center of the holding device and is caused by the resilient properties of the connecting means 3. The plant is held by the frictional resistance between the holding elements 5 and the plant itself.

As the plant grows, there is usually an increase in its diameter, especially the diameter at the transition between above-ground and underground plant parts.

The resilient properties of the connecting means 3 allow the holding elements 5 of the holding means 2 to yield to this movement caused by growth, preventing constriction of the plant which is detrimental to further growth.

FIG. 2 shows a plan view of a second exemplary embodiment of a holding device according to the invention. In the view shown in FIG. 2, the holding device is shown in a completely relaxed position.

Similar to the first exemplary embodiment, the holding device according to the second exemplary embodiment comprises a mounting means 1, which is designed as a mounting ring 4, on the inner periphery of which three connecting means 3 are arranged. The connecting means 3 are designed as angular connecting struts wherein each connecting strut 7 only has one bend 13.

On the other end of the connecting struts 7, a holding element 5 each is arranged. Together, the holding elements 5 form a holding means 2, which is designed as annular holding means 2 in this exemplary embodiment. Thus, the holding means 2 has a holding opening 6 in its center, which is adapted to receive a part of a plant. In this exemplary embodiment, the holding opening 6 is of circular design. A circular holding opening 6 distributes the pressure exerted on a plant part as evenly as possible.

Clearances 12 are arranged within the mounting ring 4, into which the holding elements 5 and the connecting means 3 can escape. The function of the holding device according to the second exemplary embodiment is analogous to that of the first exemplary embodiment and is therefore not explained in more detail here.

In this exemplary embodiment, a filler element 9 is arranged within the holding opening 6. The filler element 9 is made of an agar gel and serves to receive one or more seed/s. By influence of water, the filler element 9 dissolves over several days or weeks, completely releasing the holding opening for the germinating plant.

Preferably, the filler element 9 is designed such that it has not completely dissolved until the plant can be held by holding means 2. This is especially the case when the diameter of the plant is large enough.

FIG. 3 shows a plan view of a third exemplary embodiment of a holding device according to the invention. In the view shown in FIG. 3, the holding device is shown in a completely relaxed position.

The elements of the holding device shown in FIG. 3 substantially correspond to those of FIG. 2. The difference to the second exemplary embodiment is that the diameter of the holding opening 6 is greater in the third exemplary embodiment, which enables a plant with a greater diameter to be received. In this exemplary embodiment, no filler element 9 is provided.

FIG. 4 shows a plan view of a fourth exemplary embodiment of a holding device according to the invention. In the view shown in FIG. 4, the holding device is shown in a completely relaxed position.

The holding device according to the fourth exemplary embodiment comprises a mounting means 1, which is designed as a mounting ring 4. Four holding elements 5, which together form an annular holding means 2, are connected to the mounting ring 4 via connecting means 3. The holding means 2 has a holding opening in its center.

In this exemplary embodiment, the connecting means 3 comprise bent connecting struts 8, with two connecting struts 8 each connecting a holding element 5 to the mounting ring 4. The arcuate design of the connecting struts 8 together with the use of two connecting struts 8 per holding element 5 enhances the holding force of the holding device, since the spring force is increased. In this exemplary embodiment, each holding element 5 comprises a stabilizing element 14, which is connected to a holding jaw 16 via two connecting elements 15 each.

Thus, in this exemplary embodiment, each holding element 5 is formed by a stabilizing element 14, two connecting elements 15 and a holding jaw 16. In the completely relaxed position, the stabilizing elements 14 form a stabilizing ring 17. The connecting struts 8 are respectively arranged on the stabilizing elements 14. In the intended use of the holding device, only the holding jaws 16 are in direct contact with the plant.

FIG. 5 shows a perspective view of a fifth exemplary embodiment of a holding device according to the invention with a root cage 10. For presentation purposes, an exploded view of the two elements is shown. Except for the root cage 10, the holding device corresponds to the exemplary embodiment shown in FIG. 4, which is not explained in detail here. For clarity, not all reference signs already shown in FIG. 4 are shown in FIG. 5.

The root cage 10 has a receiving area 11 for receiving the mounting means 1, in particular the mounting ring 4. The receiving area 11 enables a positive connection between the root cage 10 and the mounting means 1. The root cage 10 has, on its underside and its lateral surface, holes 18, which serve to drain off water and to improve air circulation.

### LIST OF REFERENCE SIGNS

1 Mounting means
2 Holding means
3 Connecting means
4 Mounting ring
5 Holding element
6 Holding opening
7 Angled connecting strut
8 Arcuate connecting strut
9 Filler element
10 Root cage
11 Receiving area
12 Clearance
13 Bend
14 Stabilizing element
15 Connecting element
16 Holding jaw
17 Stabilizing ring
18 Hole

1. A holding device for plants, comprising a mounting means (1) and a holding means (2) arranged inside the mounting means (1), wherein the holding means (2) comprises at least two holding elements (5), and wherein each holding element (5) is connected to the mounting means (1) via a resilient connecting means (3), characterized in that the mounting means (1), the holding means (2) and the connecting means (3) are formed integrally with each other.

2. The holding device according to claim 1, characterized in that the mounting means (1) is designed as a mounting ring (4).

3. The holding device according to claim 1, characterized in that the holding elements (5) are substantially of circular arc-shaped design, wherein the holding elements (5) form a substantially circular holding means (2) with each other.

4. The holding device according to claim 1, characterized in that the holding means (2) is substantially circular and has a holding opening (6).

5. The holding device according to claim 1, characterized in that clearances (12) are provided within the mounting means (1), which allow free movability of the holding elements (5).

6. The holding device means according to claim 1, characterized in that at least one connecting means (3) is designed as angled connecting strut (7).

7. The holding device means according to claim 1, characterized in that at least one connecting means (3) is designed as arcuate connecting strut (8).

8. The holding device according to claim 1, characterized in that each holding element (5) is connected to the mounting means (1) via a plurality of connecting means (3).

9. The holding device according to claim 1, characterized in that the mounting means (1), the holding means (2) and/or the connecting means (3) are made of or comprise a polymer material.

10. The holding device according to claim 1, characterized in that the connecting means (3) is made of or comprises an elastic material.

11. The holding device according to claim 1, characterized in that the mounting means (1), the holding means (2) and/or the connecting means (3) has/have cavities.

12. The holding device according to claim 4, characterized in that in the holding opening (6), a filler element (9) promoting plant growth is arranged, wherein the filler element (9) is preferably made of or comprises a water-soluble polymer material.

13. The holding device according to claim 1, characterized in that the holding device comprises a preferably cylindrical root cage (10), which is connected to the mounting means (1) or can be connected to the mounting means (1).

14. The holding device according to claim 13, characterized in that the root cage (10) has a preferably annular receiving area (11), which is designed to receive the mounting means (1).

15. The holding device according to claim 13, characterized in that the root cage (10) can be positively connected to the mounting means (1).
